(19) United States
(12) Patent Application Publication
(10) Pub. No.: US 2023/0026389 A1
(43) Pub. Date: Jan. 26, 2023

(54) SERVER AND METHOD

(71) Applicant: TOSHIBA TEC KABUSHIKI KAISHA, Tokyo (JP)

(72) Inventor: Hirokazu MATSUNO, Numazu Shizuoka (JP)

(73) Assignee: TOSHIBA TEC KABUSHIKI KAISHA, Tokyo (JP)

(21) Appl. No.: 17/720,511

(22) Filed: Apr. 14, 2022

(30) Foreign Application Priority Data
Jul. 20, 2021 (JP) 2021-119714

(51) Int. Cl. G06Q 30/06

(52) U.S. Cl. CPC G06Q 30/0625; G06Q 30/0641; G06Q 30/0633

(57) ABSTRACT

A store server is configured to be installed in a store and includes a communications interface, a memory, and a processing circuit. The communications interface is configured to facilitate communication with one or more other store servers installed in one or more other stores and a user terminal within the store. The memory is configured to store other store content related to products of the one or more other stores received from the one or more other store servers. The processing circuit is configured to acquire customer identification information that identifies a customer, transmit shopping content to a user terminal carried by the customer that includes information determined based on the customer identification information and the other store content stored in the memory, acquire purchase content related to product purchased by the customer in the store, and transmit the purchase content to the one or more other store servers.

### CROSS-REFERENCE TO RELATED APPLICATION

This application is based upon and claims the benefit of priority from Japanese Patent Application No. 2021-119714, filed on Jul. 20, 2021, the entire contents of which are incorporated herein by reference.

### FIELD

Embodiments described herein relate to a server and a method.

### BACKGROUND

Recently, a method has been adopted in which a cloud server (headquarters server) that collectively manages chain stores is installed in the headquarters, and data such as contents and the like are transmitted from the cloud server to an edge server such as a store server and the like installed in each store, for example. Meanwhile, recently, since the user terminal carried by the customer is connected to the edge server and the transmission and reception of information to the user terminal increases, a large amount of data is transmitted from the edge server to the cloud server, and the load on the cloud server is increased.

Accordingly, there may be a delay in the delivery of necessary data to the edge server and the user terminal.

### DESCRIPTION OF THE DRAWINGS

FIG. 1 is a diagram illustrating an example of a system according to an embodiment;

FIG. 2 is a block diagram illustrating an example of a hardware configuration of an edge server;

FIG. 3 is a memory map illustrating a configuration of a customer information unit;

FIG. 4 is a memory map illustrating a configuration of a database;

FIG. 5 is a block diagram illustrating an example of a hardware configuration of a POS terminal;

FIG. 6 is a block diagram illustrating an example of a hardware configuration of a cloud server;

FIG. 7 is a functional block diagram illustrating an example of a functional configuration of the edge server;

FIG. 8 is a flowchart illustrating an example of controlling of the edge server;

FIG. 9 is a timing chart illustrating an example of controlling of the edge server;

FIG. 10 is an explanatory diagram illustrating an example of controlling of the edge server;

FIG. 11 is a flowchart illustrating an example of controlling of the POS terminal; and

FIG. 12 is a flowchart illustrating an example of controlling of the cloud server.

### DETAILED DESCRIPTION

In general, according to one embodiment, a server and a method are provided, which are capable of delivering necessary contents without delay.

A server according to an embodiment is capable of transmitting and receiving information to and from other store servers installed in other stores via a communication line, and includes a storage unit configured to store content related to a product of the other stores delivered from the other store servers installed in the other stores, an input unit configured to receive input customer identification information that identifies a customer, a delivery unit configured to deliver content related to the customer stored in the storage unit to a user terminal carried by the customer based on the received customer identification information, an acquisition unit configured to acquire content related to a store related to a product purchased by the customer this time or in the past, and a sharing unit configured to transmit the acquired content to the other store servers via the communication line.

Hereinafter, embodiments of a server and a method will be described with reference to the accompanying drawings. In the embodiments described below, an edge server will be described as an example of the server. Note that the embodiments are embodiments of a server and a method, and the configuration, functions, and the like thereof are not to be construed as limiting.

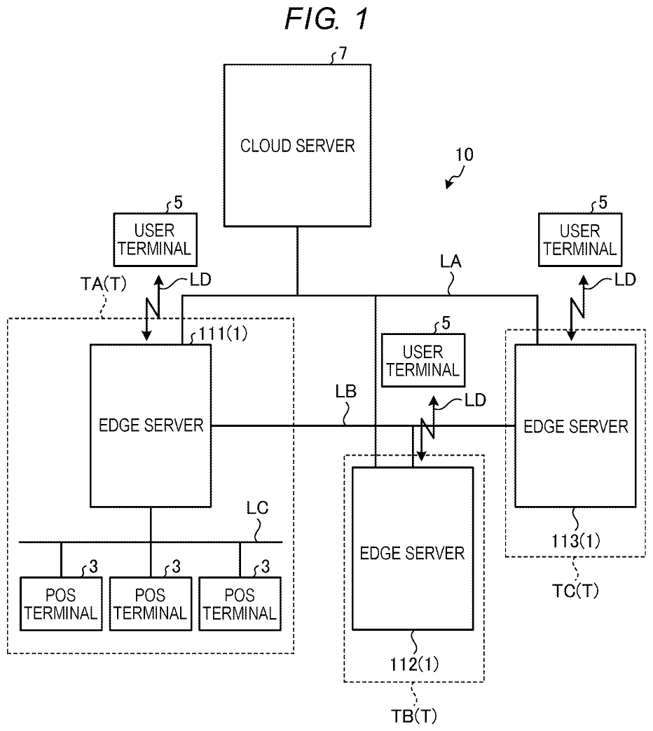

FIG. 1 is a diagram illustrating an example of a system 10 according to an embodiment. For example, the system 10 is a system for sharing contents among stores such as chain stores and the like located in the same area or small stores located in the same area. In an embodiment, the content refers to various kinds of information on the product, which is information to be displayed on the user terminal carried by the customer who visits the store. For example, the content includes information on a bargain product or a special sale product, information on a product that the store is focusing on selling, information on coupon tickets, discount tickets, or allowance tickets that can be used when purchasing products, or the like. The content includes content related to a present store and content related to another store. For example, it relates to a bargain product and a special sale product at the another store. The user terminal is a mobile terminal carried by the customer, and refers to a mobile phone, a smartphone, a tablet terminal, a Personal Digital Assistant (PDA), or the like.

The system 10 includes a plurality of edge servers 1, one or more Point of Sales (POS) terminals 3, one or more user terminals 5, and a cloud server 7. The edge server 1 is a server installed in the store T, and is a store server that manages the sales of the store T, for example. In an embodiment, the edge servers 1 (edge servers 111, 112, and 113) are installed in three stores T (stores TA, TB, and TC), respectively. One or a plurality of (three in this embodiment) POS terminals 3 (product sales data processing devices) are connected to the edge servers 111, 112, and 113, respectively (in FIG. 1, the description of the POS terminals 3 for the stores TB and TC is omitted). The edge servers 1 and the POS terminals 3 are connected to a communication line LC such as a Local Area Network (LAN) and the like, and can transmit and receive information to and from each other.

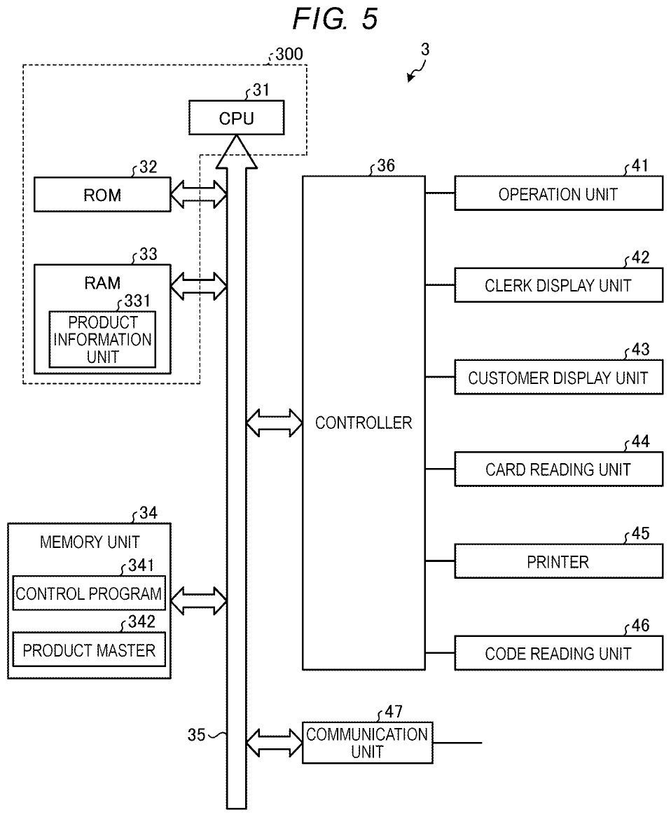

The POS terminal 3 executes a product registration process and a payment process for the product sold at the store T. The product registration process includes processes of reading a symbol attached to the product, calling and displaying product information such as a product name, a price, and the like of the product based on a product code for identifying the product associated with the symbol, and storing the same in a memory (product information unit 331, see FIG. 5). In addition, the payment process refers to a process of displaying a total amount and a change amount related to a transaction with the customer (hereinafter referred to as “payment information”) based on the product information of the product registered with the product registration process. The payment process includes a process of issuing a receipt printed with the product information and the payment information of the paid product.

The edge server 1 collects the product information and the payment information of the product processed for payment by each POS terminal 3 and manages the sales of the store T.

The edge server 1 of each store T is directly connected to the edge server 1 of another store T (another store server) by a communication line LB (e.g., a dedicated line), and can transmit and receive information to and from each other. For example, the edge server 111 of the store TA is connected to the edge server 112 of the store TB and the edge server 113 of the store TC.

In this case, in an embodiment, the stores TA, TB, and TC are chain stores opened in the same area, for example. Alternatively, the stores TA, TB, and TC are small-scale stores having the stores T in the same area, for example. There may be many stores T other than the above in this area. The stores TA, TB, and TC are the stores T (the stores T registered by the customer, which will be described below) permitted by the customer to share information and contents. The registration of a store can be done by freely designating the store at the customer's will. Accordingly, each customer may have different stores T that share the information and contents. For example, the customer registers a plurality of stores T that he or she frequently uses. Then, sharing the content related to the customer and the information on the customer (information on products purchased by the customer, information on customer purchase history, information indicating the time zone if the customer visits the store T, and the like) between the registered stores T is permitted and enabled by the customer.

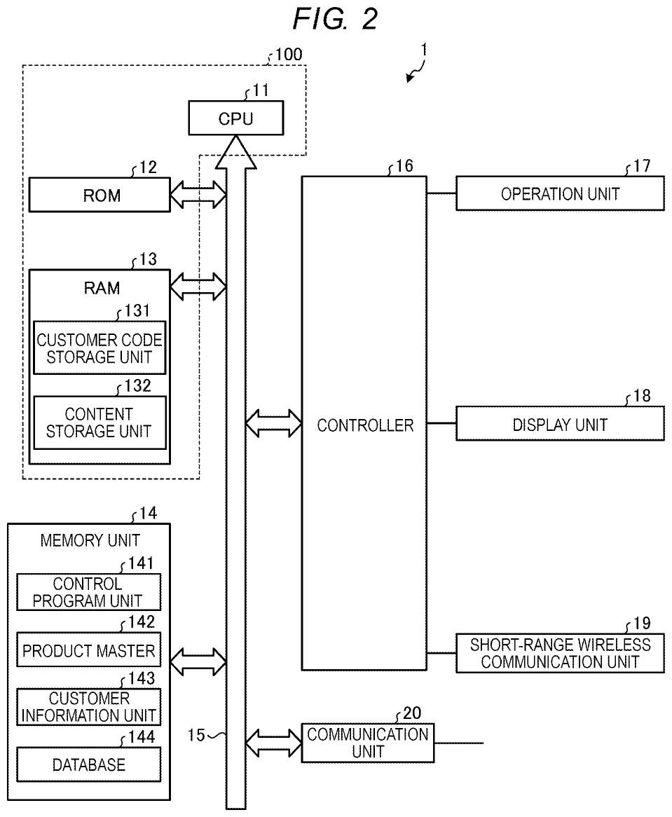

The edge server 1 acquires a customer code (customer identification information) that identifies a customer if the customer enters the store T (in this embodiment, the store TA). For example, the edge server 1 acquires a customer code from the user terminal 5 as the user terminal 5 is held up to a short-range wireless terminal (a short-range wireless communication unit 19 in FIG. 2) provided near the entrance of the store T. Further, the edge server 1 receives a beacon transmitted by the user terminal 5 to acquire the customer code included in the beacon, for example.

The edge server 1 stores the time when the customer enters the store based on the acquired customer code. Further, the edge server 1 delivers the content related to the customer issued by the store T (store TA) where the customer enters, based on the acquired customer code. The edge server 1 delivers the content to the user terminal 5 carried by the customer entering the store via a wireless communication line LD. For example, the wireless communication line LD is a wireless LAN provided in the store T, and directly connects the edge server 1 to the entrance of the store T and the user terminal 5 located in the store T. For example, the content delivered by the edge server 1 to the user terminal 5 is content related to a special sale product and a recommended product for which the store T (store TA) promotes sales, content related to a product often purchased by the customer at the store T, and the like. Further, the edge server 1 delivers information on the delivered content together with the customer code of the customer to one or more other edge servers 1 (for example, with the edge server 111 being a present store server, and the edge servers 112 and 113 being the other store servers, the edge server 111 delivers to the edge servers 112 and 113) installed in other stores T (in this embodiment, installed in the store TB and the store TC) in real time via the communication line LB. This communication line LB is a line that directly connects between the edge servers 1 without going through the cloud server 7. Therefore, the delivered content is delivered to another edge server 1 without delay. For example, the content delivered to the other store(s) T is the content for the product sold at the other store(s) T that is related to the content delivered by the customer at the store T. In addition, the customer's purchase history and behavior history, which will be described below, are also delivered to the other store(s) T.

Further, the edge server 1 delivers, to the user terminal 5, content related to the product that is on display near the customer moving in the store while the customer is shopping at the present store T (the store TA).

Further, the edge server 1 delivers, to the user terminal 5, content related to the product of another store T (in this embodiment, the store TB) that is likely to be visited next if the payment is performed on the POS terminal 3. The content related to the product of another store T that is likely to be visited next by the customer is delivered from the edge server 1 (the edge server 112) of the another store T (the store TB) that is likely to be visited next, to the edge server 1 (the edge server 111) of the present store (store TA) and stored. If there is content delivered to the customer from the edge server 1 of another store T if the customer makes a payment, the edge server 1 delivers the content to the user terminal 5 at the timing of the payment. By doing so, the customer is motivated to visit the next store T (the store TB). Further, if the customer visits the next store T and purchases a product using the delivered content, a predetermined amount may be paid from the next store T to the present store T (in this embodiment, from the store TB to the store TA).

The edge server 1 also delivers the content directly delivered to the edge server 1 of another store T to the cloud server 7 at night, for example. The delivery of the content from the edge server 1 to the cloud server 7 is performed at a low speed. Further, the transmission of sales information from the edge server 1 to the cloud server 7 is also performed at a low speed. Further, the problems of privacy and communication cost can be improved by delivering the content after data compression and feature data extraction on the edge server 1.

For example, the cloud server 7 is a server installed at the headquarters of a company. The cloud server 7 includes one or a plurality of computers. The cloud server 7 receives and manages sales information from each store T. Further, the cloud server 7 delivers a product master 142 (see FIG. 2) to the edge server 1 of each store T. The product master 142 stores product information (product name, product price, and the like) for each product corresponding to the product code. By transmitting the product master 142 to the edge server 1 of each store T, the cloud server 7 can sell the product at the same price at each store T.

Further, the cloud server 7 is connected to the edge server 1 of each store T via a dedicated line or a communication line LA which is an Internet line, for example. The content delivered from the edge server 1 of each store T is delivered to the edge server 1 of another store T. The delivery of the content from the cloud server 7 to the edge server 1 is performed at a low speed.

The hardware of the edge server 1 will be described below. FIG. 2 is a block diagram illustrating an example of a hardware configuration of the edge server 1. As illustrated in FIG. 2, the edge server 1 includes a processing circuit or Central Processing Unit (CPU) 11, a Read Only Memory (ROM) 12, a Random Access Memory (RAM) 13, a memory unit 14, and the like. The CPU 11 is a control main body. The ROM 12 stores various programs. The RAM 13 loads programs and various data. The memory unit 14 stores various programs. The CPU 11, ROM 12, RAM 13, and memory unit 14 are connected to each other via a bus 15. A control unit 100 is formed of the CPU 11, ROM 12, and RAM 13. That is, the control unit 100 executes the control process of the edge server 1, which will be described below, by operating the CPU 11 according to the control program stored in the ROM 12 or the memory unit 14 and loaded into the RAM 13.

The RAM 13 includes a customer code storage unit 131 and a content storage unit 132. The customer code storage unit 131 stores a customer code, which is customer identification information for identifying a customer, acquired (received) from the user terminal 5 by the short-range wireless communication unit 19 described below. The content storage unit 132 extracts and stores information on the content to be delivered to the user terminal 5 carried by the customer specified by the customer code stored in the customer code storage unit 131 based on the information stored in a customer information unit 143 and a content stored in a database 144, which will be described below. Specifically, the content storage unit 132 searches a purchase history unit 1432 of the corresponding customer based on the customer code stored in the customer code storage unit 131, and generates and stores a content for the product having a large purchase history. Further, the content storage unit 132 searches a behavior information unit 1433 based on the customer code stored in the customer code storage unit 131, determines (estimates) another store T that is likely to be visited next by the customer from the behavior history of the customer (accumulated information indicating the order of past customer behaviors (that is, the order of stores T visited by the customer in the past) for a plurality of stores T), and stores the content related to the customer stored in the content information unit corresponding to the store T determined by the database 144 (in this embodiment, since the store TA is the present store, in either a content information unit (store TB) 1442 delivered from the edge server 112 of the store TB, or a content information unit (store TC) 1443 delivered from the edge server 113 of the store TC).

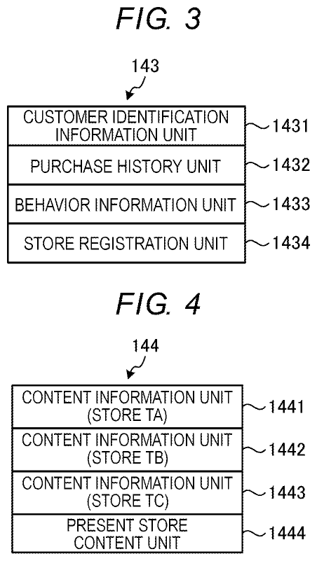

The memory unit 14 includes a non-volatile memory such as a Hard Disc Drive (HDD) or a flash memory that retains stored information even if the power is turned off, and stores a control program unit 141 storing a control program for controlling the edge server 1, the product master 142, the customer information unit 143, and the database 144. The product master 142 stores the product information of the product in association with the product code that identifies the product. The customer information unit 143 stores various kinds of information on the customer for each customer. The customer information unit 143 will be described below with reference to FIG. 3. The database 144 stores the content delivered by the edge server 1. The database 144 will be described below with reference to FIG. 4.

Further, the control unit 100 is connected to an operation unit 17, a display unit 18 (a display), and a first communications interface or the short-range wireless communication unit 19 via the bus 15 and a controller 16. The controller 16 controls the operation unit 17, the display unit 18, and the short-range wireless communication unit 19 in response to an instruction from the control unit 100. However, for convenience of explanation, it will be described that the control unit 100 performs the control performed by the controller 16.

For example, the operation unit 17 is a keyboard or a touch panel and is operated by an operator of the edge server 1. For example, the display unit 18 is a liquid crystal display and displays information for the operator of the edge server 1. For example, the short-range wireless communication unit 19 is installed at the entrance of the store T, and acquires a customer code from the user terminal 5 of the customer who enters the store T.

Further, the control unit 100 is connected to a second communications interface or a communication unit 20 via the bus 15. The communication unit 20 is connected to the cloud server 7 via the communication line LA, and transmits and receives information to and from the cloud server 7. Further, the communication unit 20 is connected to the edge server 1 installed in another store T via the communication line LB, and directly transmits and receives information to and from the edge server 1. Further, the communication unit 20 is connected to the POS terminal 3 via the communication line LC, and transmits and receives information to and from the POS terminal 3. The communication unit 20 is directly connected to the user terminal 5 via the wireless communication line LD, and transmits and receives information to and from the user terminal 5.

Next, the customer information unit 143 will be described. FIG. 3 is a memory map illustrating a configuration of the customer information unit 143. As illustrated in FIG. 3, the customer information unit 143 stores various kinds of information on a customer for each customer. The customer information unit 143 includes a customer identification information unit 1431, the purchase history unit 1432, the behavior information unit 1433, and a store registration unit 1434. The customer identification information unit 1431 stores a customer code that identifies a customer. In addition, the various kinds of information (name, address, telephone number, address of the user terminal 5, and the like) on the customer is stored in the customer identification information unit 1431. The purchase history unit 1432 cumulatively stores the product information of the products purchased by the customer in the past in association with the customer code stored in the customer identification information unit 1431. The behavior information unit 1433 stores the behavior history of the customer in association with the customer code stored in the customer identification information unit 1431. Specifically, the behavior information unit 1433 stores customer flow between the registered stores T based on entry date and time, payment date and time, and the like for each store T. Based on the customer flow (behavior history) stored in the behavior information unit 1433, the order of the stores T visited by the customer can be estimated. Although the customer information unit 143 for only one customer is illustrated in FIG. 3, in reality, there are customer information units 143 as many as the number of customers and for each of the customers. The store registration unit 1434 stores (registers) the store T designated by the customer. The stores T stored in the store registration unit 1434 are in the same group. The content related to the customer is transmitted and shared between the edge servers 1 installed in the stores T stored in the store registration unit 1434.

Next, the database 144 (storage unit) will be described. FIG. 4 is a memory map illustrating a configuration of the database 144. The database 144 stores, for each store T, the contents delivered by the edge server 1 of each store T. In an embodiment, as illustrated in FIG. 4, the database 144 includes a content information unit (store TA) 1441, the content information unit (store TB) 1442, the content information unit (store TC) 1443, and a present store content unit 1444.

The content information unit (store TA) 1441 stores the content delivered to another store T by the edge server 111 of the store TA. The content information unit (store TA) 1441 includes content for each customer generated by the edge server 111 of the store TA. The edge server 111 of the store TA stores information on the product that the customer often purchases at the store TA, information on the special sale product offered at the store TA, and contents of coupon tickets, discount tickets, allowance tickets, and the like that can be used at the store TA related to these products, based on the purchase history of the customer and the like.

The content information unit (store TB) 1442 stores the content delivered to another store T by the edge server 112 of the store TB. The content information unit (store TB) 1442 includes content for each customer generated by the edge server 112 of the store TB. The edge server 112 of the store TB stores information on the product that the customer often purchases at the store TB, information on special sale product offered at the store TB, and contents of coupon tickets, discount tickets, allowance tickets, and the like that can be used at the store TB related to these products, based on the purchase history of the customer and the like.

The content information unit (store TC) 1443 stores the content delivered to another store T by the edge server 113 of the store TC. The content information unit (store TC) 1443 includes content for each customer generated by the edge server 113 of the store TC. The edge server 113 of the store TC stores information on the product that the customer often purchases at the store TC, information on the special sale product offered at the store TC, and contents of coupon tickets, discount tickets, allowance tickets, and the like that can be used at the store TC related to these products, based on the purchase history of the customer and the like.

The present store content unit 1444 stores the content to be delivered to the user terminal 5 carried by the customer who visits the present store T. The present store content unit 1444 stores information on the special sale product of the present store T, information on products that the customer often purchases at the present store T based on the purchase history of the customer, and contents of coupon tickets, discount tickets, allowance tickets, and the like that can be used at the present store T.

Although the database 144 for only one customer is illustrated in FIG. 4, in reality, there are databases 144 for as many as the number of customers and for each of the customers.

Next, the hardware of the POS terminal 3 will be described. FIG. 5 is a block diagram illustrating an example of a hardware configuration of the POS terminal 3. As illustrated in FIG. 5, the POS terminal 3 includes a processing circuit or CPU 31, a ROM 32, a RAM 33, a memory unit 34, and the like. The CPU 31 is a control main body. The ROM 32 stores various programs. The RAM 33 loads programs and various data. The memory unit 34 stores various programs. The CPU 31, ROM 32, RAM 33, and memory unit 34 are connected to each other via a bus 35. The CPU 31, ROM 32, and RAM 33 configure a control unit 300. That is, the control unit 300 executes a control process of the POS terminal 3, which will be described below, by operating the CPU 31 according to the control program stored in the ROM 32 or the memory unit 34 and loaded into the RAM 33.

The RAM 33 includes a product information unit 331. The product information unit 331 stores the product information (product name, product price, and the like) of the product registered through the product registration process.

The memory unit 34 includes a non-volatile memory such as a Hard Disc Drive (HDD) or a flash memory that retains stored information even if the power is turned off, and stores a control program unit 341 storing a control program for controlling the POS terminal 3, and a product master 342. The product master 342 stores the product information of the product in association with the product code that identifies the product to be sold at the store T.

Further, the control unit 300 is connected to an operation unit 41, a clerk display unit 42 (a clerk display), a customer display unit 43 (a customer display), a card reading unit 44 (a card reader), a printer 45, and a code reading unit 46 (a code reader) via the bus 35 and a controller 36. The controller 36 receives an instruction from the control unit 300 and controls the operation unit 41, the clerk display unit 42, the customer display unit 43, the card reading unit 44, the printer 45, and the code reading unit 46. However, for convenience of explanation, it will be described that the control unit 300 performs the control performed by the controller 36.

For example, the operation unit 41 is a keyboard or a touch panel and is operated by an operator of the POS terminal 3. For example, the clerk display unit 42 is a liquid crystal display and displays information for the clerk who is the operator of the POS terminal 3. For example, the customer display unit 43 is a liquid crystal display and displays information for the customer. The card reading unit 44 reads the customer code from the card (e.g., credit card, electronic money, and the like) used by the customer for payment. The control unit 300 of the POS terminal 3 executes the payment process related to the customer based on the read customer code. The printer 45 issues a receipt or a slip printed with the product information and the payment information of the product registered with the product registration process. The code reading unit 46 captures or optically reads the symbol such as a barcode, a two-dimensional code, and the like attached to the product. The control unit 300 of the POS terminal 3 executes the product registration process related to the product based on the read symbol.

Further, the control unit 300 is connected to a communication unit 47 via the bus 35. The communication unit 47 is connected to the edge server 1 via the communication line LC and transmits and receives information.

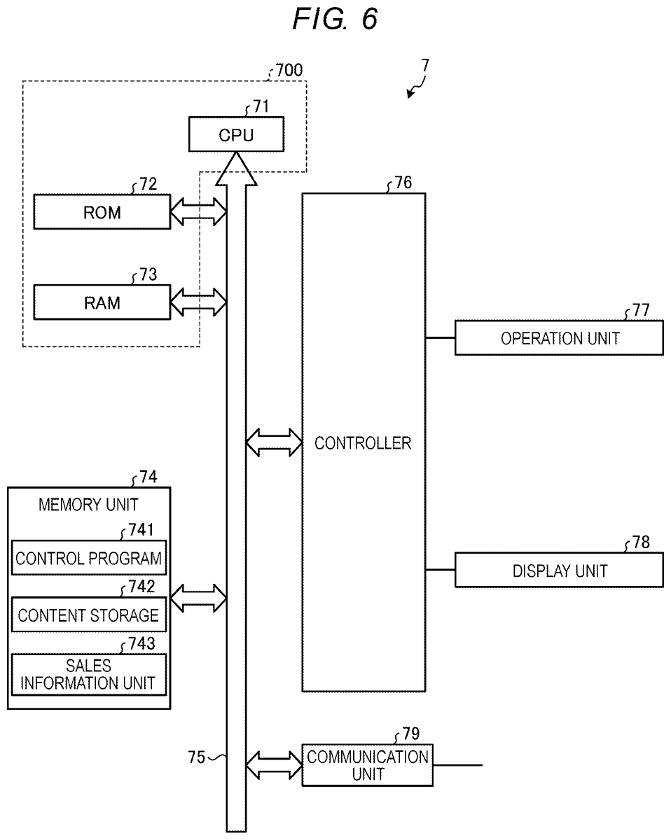

Next, the hardware of the cloud server 7 will be described. FIG. 6 is a memory map illustrating a configuration of the cloud server 7. As illustrated in FIG. 6, the cloud server 7 includes a processing circuit or CPU 71, a ROM 72, a RAM 73, a memory unit 74, and the like. The CPU 71 is a control main body. The ROM 72 stores various programs. The RAM 73 loads programs and various data. The memory unit 74 stores various programs. The CPU 71, ROM 72, RAM 73, and memory unit 74 are connected to each other via a bus 75. A control unit 700 is formed of the CPU 71, the ROM 72, and the RAM 73. That is, the control unit 700 executes the control process of the cloud server 7, which will be described below, by operating the CPU 71 according to the control program stored in the ROM 72 or the memory unit 74 and loaded into the RAM 73.

The memory unit 74 includes a non-volatile memory such as a Hard Disc Drive (HDD), a flash memory, and the like that retains stored information even if the power is turned off, and stores a control program unit 741 storing a control program for controlling the cloud server 7, a content storage unit 742, and a sales information unit 743. The content storage unit 742 stores the content transmitted from the edge server 1. The control unit 700 transmits the content stored in the content storage unit 742 to the edge server 1 of another store T. The sales information unit 743 aggregates and stores the sales information of each store T received from each store T.

Further, the control unit 700 is connected to an operation unit 77 and a display unit 78 (a display) via the bus 75 and a controller 76. The controller 76 controls the operation unit 77 and the display unit 78 in response to an instruction from the control unit 700. However, for convenience of explanation, it will be described that the control unit 700 performs the control performed by the controller 76.

For example, the operation unit 77 is a keyboard or a touch panel and is operated by an operator of the cloud server 7. For example, the display unit 78 is a liquid crystal display and displays information for the operator of the cloud server 7.

Further, the control unit 700 is connected to a communication unit 79 via the bus 75. The communication unit 79 is connected to each edge server 1 via the communication line LA and transmits and receives information.

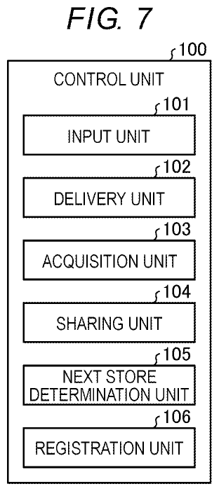

Next, a functional configuration of the edge server 1 will be described. FIG. 7 is a functional block diagram illustrating a functional configuration of the edge server 1. As illustrated in FIG. 7, according to the control program stored in the control program unit 141 of the ROM 12 or the memory unit 14, the control unit 100 of the edge server 1 serves as an input unit 101, a delivery unit 102, an acquisition unit 103, a sharing unit 104, a next store determination unit 105, and a registration unit 106.

The input unit 101 receives a customer code that identifies the input customer. Specifically, the input unit 101 stores the customer code (acquired by the short-range wireless communication unit 19) received from or acquired by the short-range wireless communication unit 19 in the customer code storage unit 131.

The delivery unit 102 delivers information of the content related to the customer stored in the content storage unit 132 based on the received customer code to the user terminal 5 carried by the customer. Specifically, the delivery unit 102 searches the database 144 based on the customer code stored in the customer code storage unit 131, and delivers content suitable for the customer to the user terminal 5 carried by the customer based on the purchase history of the customer specified by the customer code.

The acquisition unit 103 acquires the content related to the store T related to the product purchased by the customer this time or in the past. Specifically, based on the purchase history of the customer stored in the purchase history unit 1432 and the behavior history of the customer stored in the behavior information unit 1433, the acquisition unit 103 stores, from the content to be delivered to the customer stored in the database 144, content to be delivered to the user terminal 5 carried by the customer if the customer enters the store T, content to be delivered to the user terminal 5 carried by the customer while shopping at the store T, and content to be delivered to the user terminal 5 carried by the customer at the time of payment, in the content storage unit 132 and the database 144 (if the store TA is the present store, stored in the content information unit (store TA) 1441).

The sharing unit 104 transmits the acquired content to the edge server 1 of another store T via the communication line LB. Specifically, the sharing unit 104 transmits the content acquired by the acquisition unit 103 and stored in the database 144 (if the store TA is the present store, stored in the content information unit (store TA) 1441) in real time together with the customer code of the customer via the communication line LB. This transmission is directly delivered from the edge server 1 to another edge server 1 without going through the cloud server 7.

The next store determination unit 105 determines, among the other stores T, the next store T that is likely to be visited next by the customer. Specifically, the next store determination unit 105 predicts the next store T that is likely to be visited next by the customer, based on the customer's behavior history stored in the behavior information unit 1433. More specifically, the next store determination unit 105 predicts the next store T that is likely to be visited next by the customer based on the behavior history such as the store entry date and time, the payment date and time, and the like of the customer for each store T stored in the behavior information unit 1433.

The registration unit 106 registers a plurality of stores T in advance. Specifically, the registration unit 106 registers in the store registration unit 1434 in advance a plurality of stores T designated by the customer to share content. The behavior information unit 1433 stores the behavior history such as the store entry date and time, the payment date and time, and the like of the customer for the plurality of stores T registered by the registration unit 106.

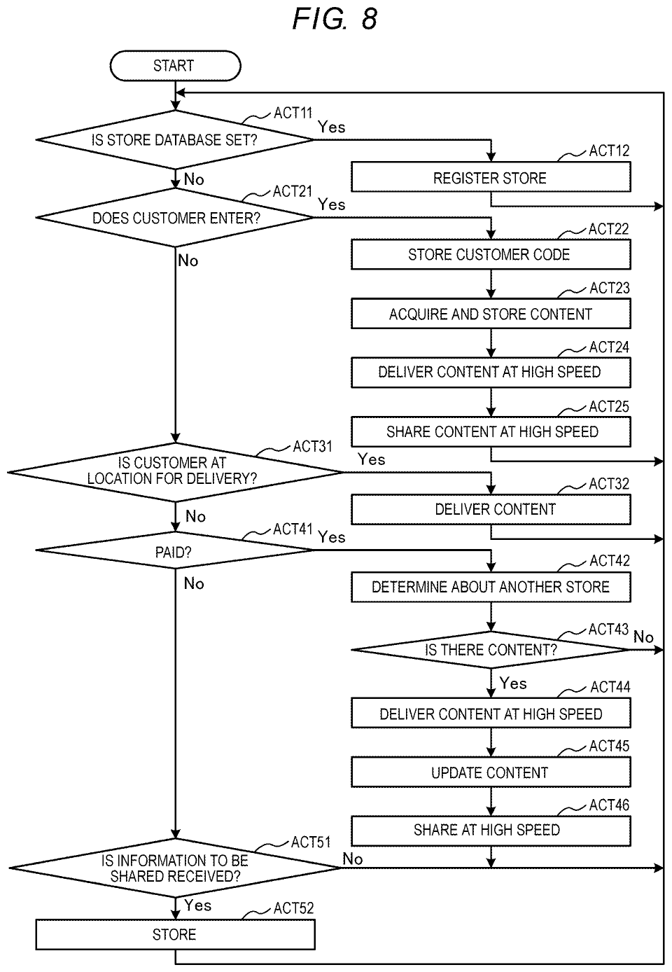

Next, controlling of the edge server 1 will be described. FIG. 8 is a flowchart illustrating an example of controlling of the edge server 1. As illustrated in FIG. 8, the control unit 100 of the edge server 1 determines whether or not the store T is designated (ACT11). The customer operates the user terminal 5 to designate the store T to share the content with. If it is determined that the store T is designated (Yes in ACT11), the registration unit 106 stores (registers) the designated store T in the store registration unit 1434 (ACT12). That is, a group of stores T designated by the customer is formed. Then, the control unit 100 returns to ACT11.

If it is determined that the store T is not designated (No in ACT11), the control unit 100 determines whether or not the customer enters the store (specifically, determines whether the short-range wireless communication unit 19 acquires the customer code) (ACT21). If it is determined that the customer enters the store (Yes in ACT21), the input unit 101 stores the input customer code specifying the customer in the customer code storage unit 131 (that is, receives the input customer code) (ACT22). Further, the control unit 100 stores the store entry date and time of the customer received at the same time in the behavior information unit 1433. Then, the acquisition unit 103 acquires from the present store content unit 1444 the content related to the customer and the content that the store T wants to deliver, and stores the acquired content in the content storage unit 132 (ACT23). Further, the acquisition unit 103 stores the content related to the customer delivered from another store T in the content storage unit 132 (ACT23). For example, if the present store is store TA, the acquisition unit 103 acquires the content for store TB related to the customer from the content information unit (store TB) 1442 and stores the acquired content in the content storage unit 132 (ACT23). Further, the acquisition unit 103 acquires the content for store TC related to the customer from the content information unit (store TC) 1443 and stores the acquired content in the content storage unit 132 (ACT23). Further, the acquisition unit 103 stores the content stored in the content storage unit 132 in the database 144 (for the present store TA, stored in the content information unit (store TA) 1441).

Next, the delivery unit 102 delivers the content stored in the content storage unit 132 to the user terminal 5 carried by the customer via the wireless communication line LD (ACT24). Note that the delivery unit 102 may not deliver all the contents stored in the content storage unit 132 to the user terminal 5. The content related to a specific product may be delivered by the process of ACT32 as described below. Further, the content related to another store T may be delivered by the process of ACT44 as described below.

Next, the sharing unit 104 directly transmits the content stored in the database 144 in ACT23 to the edge server 1 of another store T via the communication line LB (ACT25). For example, if the present store is the store TA, the delivery unit 102 transmits the content stored in the content information unit (store TA) 1441 of the edge server 111 to the edge server 112 of the store TB and the edge server 113 of the store TC via the wireless communication line LB. In this way, the content stored in the database 144 is transmitted (delivered) as shared data to the edge server 1 of another store T. The shared data is stored in each edge server 1. Then, the control unit 100 returns to ACT11. The information directly transmitted in ACT25 is transmitted from the edge server 1 to the cloud server 7 via the communication line LA as backup information by batch processing at night, for example. The transmission of information to the cloud server 7 via the communication line LA is performed at a low speed.

If it is determined that the customer does not enter the store (No in ACT21), the control unit 100 determines whether or not the customer is located near the display of a specific product (e.g., a special sale product or a product recommended by the store T) (ACT31). Whether or not the customer is located near the specific product can be determined by catching the beacon (radio wave including the customer code information) transmitted by the user terminal 5 carried by the customer, by the receiver at the position, for example. If it is determined that the customer is located near the display of the specific product (Yes in ACT31), the delivery unit 102 delivers the content stored in the content storage unit 132 related to the product to the user terminal 5 carried by the customer via the wireless communication line LD (ACT32).

If it is determined that the customer is not located near the specific product (No of ACT31), the control unit 100 determines whether or not the payment process is executed on the POS terminal 3 for a transaction related to the customer (ACT41). Whether or not the payment process of the control unit 100 is executed is determined based on whether or not a payment signal (including the customer code) indicating that the payment process is executed is received from the POS terminal 3. When receiving the payment signal, the control unit 100 determines that the payment process is executed for the transaction of the corresponding customer.

If it is determined that the payment process is executed on the POS terminal 3 (Yes in ACT41), the control unit 100 stores the payment date and time in the behavior information unit 1433 of the customer. Then, the next store determination unit 105 determines another store T that is likely to be visited next by the customer among the stores T registered by the customer in ACT12 (ACT42). Next, the control unit 100 determines whether or not the content storage unit 132 contains content for the customer related to another store T that is determined to be likely to be visited next by the next store determination unit 105 (ACT43). If it is determined that the content for the customer related to another store T is included (Yes in ACT43), the delivery unit 102 delivers the content for the customer related to another store T via the wireless communication line LD (ACT44).

Next, the control unit 100 updates the data stored in the purchase history unit 1432 based on the payment information of the customer, and updates the data stored in the behavior information unit 1433 based on the store entry date and time and the payment date and time of the customer (ACT45). In addition, with the update of the data of the purchase history unit 1432 and the behavior information unit 1433, the content information stored in the content information unit of the present store (if the store TA is the present store, the content information stored in the content information unit (store TA) 1441 related to the customer) is updated (ACT45). Then, the sharing unit 104 transmits the information updated in ACT45 related to the customer (data stored in the purchase history unit 1432, data stored in the behavior information unit 1433, content stored in the content information unit of the present store (if the store TA is the present store, content stored in the content information unit (store TA) 1441 related to the customer) to the edge server 1 of another store T via the communication line LB (ACT46). The information transmitted in ACT46 is stored in each edge server 1 as shared data. Then, the control unit 100 returns to ACT11. The information directly transmitted in ACT46 is transmitted from the edge server 1 to the cloud server 7 as backup information by batch processing at night via the communication line LA. The transmission of information to the cloud server 7 via the communication line LA is performed at a low speed.

When determining that the payment process is not executed (No in ACT41), the control unit 100 determines whether or not the shared data is received from another edge server 1 (in this embodiment, from the edge servers 112 and 113) (ACTS 1). When determining that the shared data is received (Yes in ACT51), the control unit 100 stores the shared data in the database 144 (ACT52). For the edge server 111, if the shared data is received from the edge server 112, the control unit 100 stores the shared data in the content information unit (store TB) 1442. If the shared data is received from the edge server 113, the control unit 100 stores the shared data in the content information unit (store TC) 1443. Then, the control unit 100 returns to ACT11.

If it is determined that the shared data is not received (No in ACT51), the control unit 100 returns to ACT11.

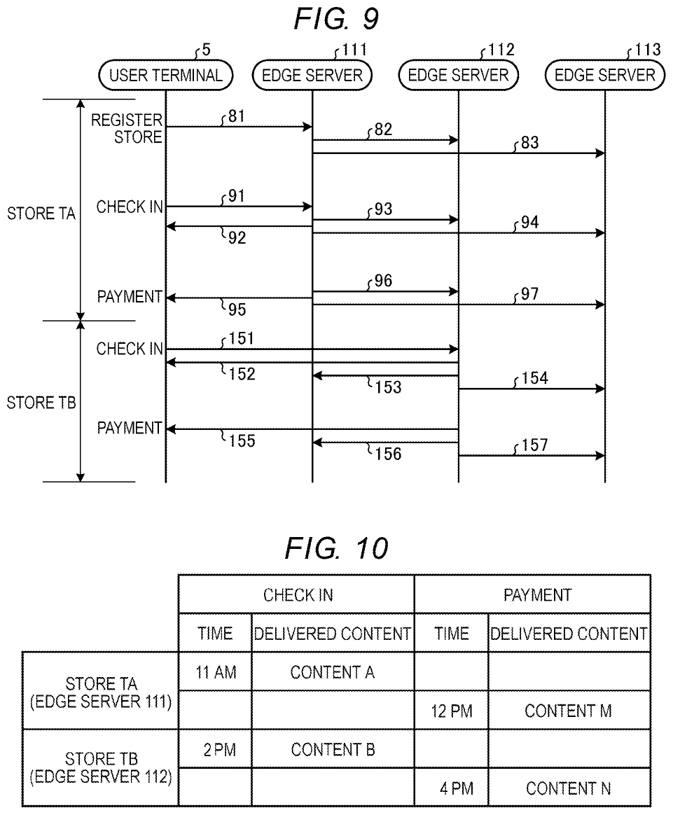

The delivery and sharing of content by each edge server 1 will be described below, in which the store TA is the present store and the store TB and the store TC are other stores T. FIG. 9 is a timing chart illustrating an example of controlling of each edge server 1. FIG. 10 is an explanatory diagram illustrating an example of controlling of the edge server 1 in FIG. 9. As illustrated in FIGS. 9 and 10, the customer registers the stores T for grouping the stores T in the store TA in advance. In the example of FIG. 9, the customer operates the user terminal 5 of the customer in the store TA to designate the stores TA, TB, and TC in order to group the stores TA, TB, and TC. Specifically, for example, among the plurality of stores T displayed on the user terminal 5, the stores TA, TB, and TC are designated. Then, the user terminal 5 transmits the designated stores TA, TB, and TC to the edge server 111 of the store TA (arrow 81). The edge server 111 registers (groups) the stores TA, TB, and TC designated from the user terminal 5. Further, the edge server 111 transmits information on grouping of the stores TA, TB, and TC to the edge server 112 of the store TB and the edge server 113 of the store TC (arrow 82 and arrow 83).

Next, if the customer enters the store TA (checks in), the customer code of the customer acquired by the short-range wireless communication unit 19 and the acquired date and time (entry date and time (11:00 AM in FIG. 10)) are transmitted to the edge server 111 (arrow 91). The edge server 111 stores the received customer code and date and time, acquires first content related to the customer, and delivers the acquired first content to the user terminal 5 of the customer (arrow 92). In FIG. 10, the first content or content A is delivered to the user terminal 5 at this timing. Then, the edge server 111 transmits information on the customer code, the entry date and time, and the content A to the edge servers 112 and 113 registered in the same group via the communication line LB (information sharing).

Next, the customer makes a payment at the store TA. At this time, if the delivered content A is a coupon ticket, a discount ticket, or an allowance ticket, the customer can use the content A at the time of payment on the POS terminal 3. When completing the payment process, the POS terminal 3 transmits the date and time of the payment process (12:00 PM in FIG. 10), the product information and the payment information on the transaction to the edge server 111 together with the customer code. The edge server 111 stores the received customer code and date and time, and delivers second content related to the customer to the user terminal 5 of the customer (arrow 95). In FIG. 10, the second content or content M is delivered to the user terminal 5 at this timing. For example, the content M is information on the content related to the store TB, which is delivered as the shared information from the edge server 112. When determining that the store T to be visited next is likely to be the store TB, the edge server 111 delivers the content M delivered from the edge server 112 of the store TB to the user terminal 5. Then, the edge server 111 transmits information on the customer code, the entry date and time, and the content M to the edge servers 112 and 113 registered in the same group via the communication line LB (information sharing).

Next, the customer visits the store TB. If the customer enters the store TB, the customer code of the customer acquired by the short-range wireless communication unit 19 and the acquired date and time (entry date and time (2:00 PM in FIG. 10)) are transmitted to the edge server 112 (arrow 151). The edge server 112 stores the received customer code and date and time, acquires third content related to the customer, and delivers the acquired third content to the user terminal 5 of the customer (arrow 152). In FIG. 10, the third content or content B is delivered to the user terminal 5 at this timing. Then, the edge server 112 transmits information on the customer code, the entry date and time, and the content B to the edge servers 111 and 113 registered in the same group via the communication line LB (arrow 153, arrow 154) (information sharing).

Next, the customer makes a payment at the store TB. At this time, if the delivered content B is a coupon ticket, a discount ticket, or an allowance ticket, the customer can use the content B at the time of payment on the POS terminal 3. When completing the payment process, the POS terminal 3 transmits the date and time of the payment process (4:00 PM in FIG. 10), the product information and the payment information on the transaction to the edge server 112 together with the customer code. The edge server 112 stores the received customer code and date and time, and delivers fourth content related to the customer to the user terminal 5 of the customer (arrow 155). In FIG. 10, the fourth content or content N is delivered to the user terminal 5 at this timing. For example, the content N is information on the content related to the store TC, which is delivered as the shared information from the edge server 113. When determining that the store T to be visited next is likely to be the store TC, the edge server 112 delivers the content N delivered from the edge server 113 of the store TC to the user terminal 5. Then, the edge server 112 transmits information on the customer code, the entry date and time, and the content N to the edge servers 111 and 113 registered in the same group via the communication line LB (arrow 156 and arrow 157) (information sharing).

As described above, since the edge server 1 directly transmits and receives the content to and from other edge servers 1, it delivers the information necessary for the customer without delay. Further, since the transmission and reception of information to and from the cloud server 7 is reduced, the burden on the cloud server 7 can be reduced.

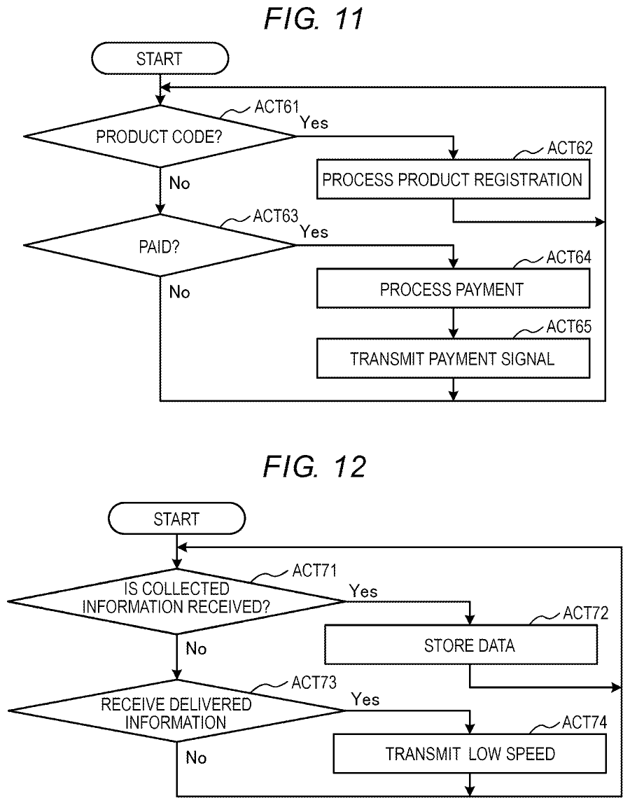

The controlling of the POS terminal 3 will now be described below. FIG. 11 is a flowchart illustrating an example of controlling of the POS terminal 3. As illustrated in FIG. 11, the control unit 300 of the POS terminal 3 determines whether or not the code reading unit 46 reads the symbol attached to the product and acquires the corresponding product code (ACT61). If it is determined that the product code is acquired (Yes in ACT61), the control unit 300 executes the product registration process (including the process of storing product information in the product information unit 331) related to the product based on the product code (ACT62). Then, the control unit 300 returns to ACT61.

If it is determined that the product code is not acquired (No in ACT61), the control unit 300 determines whether or not a payment operation such as pressing a payment key (not illustrated) is performed (ACT63). If it is determined that the payment operation is performed (Yes in ACT63), the control unit 300 executes the payment process related to the transaction based on the product information stored in the product information unit 331 (ACT64). Then, the control unit 300 transmits the product information and the payment information of the product processed for payment, and a payment signal including the customer code of the customer related to the transaction to the edge server 1. In addition, the payment signal also includes information on the date and time of the payment process.

The controlling of the cloud server 7 will now be described below. FIG. 12 is a flowchart illustrating an example of controlling of the cloud server 7. As illustrated in FIG. 12, the control unit 700 of the cloud server 7 determines whether or not the information received from the edge server 1 is collected information (e.g., sales information at the store T) collected and accumulated by the cloud server 7 (ACT71). When determining that it is the collected information (Yes in ACT71), the control unit 700 accumulates and stores the received collected information in the sales information unit 743 (ACT72). Then, the control unit 700 returns to ACT71.

When determining that it is not the collected information (No in ACT71), the control unit 700 determines whether or not the information received from the edge server 1 is the information to be delivered to another edge server 1 (e.g., the information transmitted in ACT25 and ACT46) (ACT73). When determining that it is the information to be delivered to another edge server 1 (Yes in ACT73), the control unit 700 transmits the information to another edge server 1. This transmission is performed at a low speed. Then, the control unit 700 returns to ACT71. When determining that it is not the information to be delivered to another edge server 1 (No in ACT73), the control unit 700 returns to ACT71.

As described above, the edge server 1 according to the embodiment is a server that is directly connected to the edge server 1 installed in another store T via the communication line LB to be able to transmit and receive information to and from the other store T, and includes the database 144 storing the content related to a product of the another store T delivered from the edge server 1 installed in the other store T, the input unit 101 configured to receive an input customer code that identifies a customer, the delivery unit 102 configured to deliver content information related to the customer stored in the database 144 based on the received customer code to the user terminal 5 carried by the customer, the acquisition unit 103 configured to acquire the content information related to the store T related to the product purchased by the customer this time or in the past, and the sharing unit 104 configured to transmit the acquired content information to the edge server 1 of the other store T via the communication line LB.

The edge server 1 of such an embodiment directly transmits the content to another edge server 1 via the communication line LB. That is, since the content can be shared between the edge servers 1 without going through the cloud server 7, it is possible to deliver the necessary content without delay. Further, according to the edge server 1 of the embodiment, it is possible to deliver accurate contents for the customer. Further, according to the edge server 1 of the embodiment, since the content is transmitted to the edge server 1 without passing through the cloud server 7, the burden on the cloud server 7 can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in certain embodiment, the content to be delivered to the customer or the content to be transmitted to another edge server 1 was described as the information on the bargain product or the special sale product, the information on the product that the store T is focusing on selling, the information on the coupon ticket, the discount ticket, or an allowance ticket that can be used when purchasing products, or the like, for example. However, embodiments are not limited thereto, and the content may be various kinds of information on the product, and may be any information displayed on the user terminal 5 carried by the customer who visits the store T.

Further, in an embodiment, the store server was described as an example of the edge server 1. However, embodiments are not limited thereto, and the edge server 1 may be a server other than the store server as long as it is a server installed in the store T.

Further, in an embodiment, the store T where the products are sold was described as an example. However, embodiments are not limited thereto, and the store T may be a restaurant, for example. In this case, the edge server 1 may deliver the restaurant menu to the user terminal 5 as the content at the time of entry.

Further, in an embodiment, a method by data linkage between the edge servers 1 without going through the cloud server 7 was described. However, embodiments are not limited thereto, and if there is information that should be utilized by high-speed customer analysis on the cloud server 7, or if there is information necessary in real time for API linkage with other cloud servers 7, and so on, the information may be selectively communicated at a high speed and in real time.

The program executed on the edge server 1 according to an embodiment is provided as a file in an installable format or an executable format recorded on a computer-readable recording medium such as a CD-ROM, a flexible disk (FD), a CDR, a Digital Versatile Disk (DVD) and the like.

Further, it may be configured such that the program executed by the edge server 1 according to an embodiment is stored on a computer connected to a network such as the Internet and the like and provided by being downloaded via the network. Further, it may be configured such that the program executed by the edge server 1 according to an embodiment is provided or distributed via a network such as the Internet and the like.

Further, it may be configured such that the program executed by the edge server 1 according to an embodiment is incorporated into ROM or the like in advance and provided.

What is claimed is:

1. A server system capable of transmitting information between a plurality of store servers installed in a plurality of stores, the server system comprising:
a first store server configured to be installed in a first store of the plurality of stores, the first store server including:
a communications interface configured to facilitate communication with (i) one or more other store servers of the plurality of store servers installed in one or more other stores of the plurality of stores and (ii) a user terminal within the first store;
a memory configured to store other store content related to products of the one or more other stores received from the one or more other store servers installed in the one or more other stores; and
a processing circuit configured to:
acquire customer identification information that identifies a customer;
transmit shopping content to a user terminal carried by the customer that includes information determined based on the customer identification information and the other store content stored in the memory;
acquire purchase content related to product purchased by the customer in the first store; and
transmit the purchase content to the one or more other store servers.

2. The server system according to claim 1, wherein the shopping content also includes information on product that the first store wants to sell to the customer.

3. The server system according to claim 1, wherein the processing circuit is configured to:
determine, among the one or more other stores, a next store that is likely to be visited next by the customer;
transmit, to the user terminal, the other store content associated with the next store that is determined to be likely to be visited next.

4. The server system according to claim 3, wherein the processing circuit is configured to determine the next store that is likely to visit next based on a past behavior history showing an order of behaviors of the customer.

5. The server system according to claim 1, wherein the processing circuit is configured to receive advanced registration of a plurality of stores in advance including the first store and at least one of the one or more other stores from the customer.

6. The server system according to claim 1, wherein the communications interface includes:
a first communications interface configured to communicate with the one or more other store servers via a communication line; and
a second communications interface configured to communicate wirelessly with the user terminal within the first store.

7. The server system according to claim 1, further comprising a cloud server, wherein the communications interface facilitates communication with the cloud server, and wherein the first store server communicates with (i) the one or more other store servers using a first communication line and (ii) the cloud server using a second communication line.

8. The server system according to claim 7, wherein communication via the first communication line is faster than communication via the communication second line.

9. The server system according to claim 7, wherein communication via the first communication line is performed sooner than communication via the second communication line.

10. The server system according to claim 7, wherein the processing circuit is configured to transmit the purchase content to the cloud server.

11. A server system comprising:
a cloud server;
a first store server configured to be installed in a first store; and
a second store server configured to be installed in a second store;
wherein:
the first store server is connected to the second store server via a first communication line;
the cloud server is connected to the first store server and the second store server via a second communication line
the first store server includes:
a communications interface configured to facilitate wireless communication with a user terminal within the first store; and
a processing circuit configured to:
acquire customer identification information that identifies a customer using the user terminal;
acquire other store content from the second server;
acquire purchase content related to first product purchased by the customer in the first store;
transmit the purchase content and the customer identification information to (i) the second store server via the first communication line and (ii) the cloud server via the second communication line; and
transmit the other store content to the user terminal including product information of second product sold at the second store, wherein the product information provided to the user terminal is based on at least one of (i) the first product purchased in the first store or (ii) a past behavior of the customer.

12. The server system according to claim 11, wherein communication via the first communication line is faster than communication via the communication second line.

13. The server system according to claim 11, wherein communication via the first communication line is performed sooner than communication via the second communication line.

14. The server system according to claim 11, wherein the processing circuit is configured to transmit shopping content to the user terminal that includes information regarding product sold at the first store that is determined based on at least one of the customer identification information or the other store content.

15. The server system according to claim 11, wherein the processing circuit is configured to transmit shopping content to the user terminal that includes information regarding product sold at the first store that the first store wants to entice the customer to purchase.

16. The server system according to claim 1, wherein the processing circuit is configured to receive advanced registration of the first store and the second store from the customer such that information related to the customer is shared between the first store server and the second store server.

17. A method for transmitting and receiving information between store servers installed in different stores via a communication line, the method comprising:
storing, by a first server installed in a first store, second store content related to product of a second store received from a second server installed in the second store;
receiving, by the first server, customer identification information that identifies a customer in the first store;
transmitting, by the first server, shopping content to a user terminal carried by the customer that includes information determined based on the received customer identification information and the second store content;
acquiring, by the first server, purchase content related to product purchased by the customer in the first store; and
transmitting, by the first server, the purchase content to the second store server via the communication line.
